(19) United States
(12) Patent Application Publication
(10) Pub. No.: US 2011/0116181 A1
(43) Pub. Date: May 19, 2011

(54) Primary Collimation Assist

(76) Inventor: James Sofia, Ottawa (CA)

(21) Appl. No.: 12/618,759

(22) Filed: Nov. 15, 2009

(51) Int. Cl. G02B 23/10; G02B 7/198; G02B 7/183

(52) U.S. Cl. 359/877

(57) ABSTRACT

Primary Collimation Assist (PCA) will allow one to collimate the primary mirror of a dobsonian telescope completely from the location of the focuser by remotely turning the telescope's collimation knobs by operating a transmitter. Usage requirements for the current version of the invention are that the collimation knob be hexagonal in shape with a ⅞ inch socket size and the telescope have upper adjoining structural support beams in the mirror box or ceilings housing the collimation knob so as to adhere 2 two inch Velcro strips on either side of the collimation knob to attach three servo motors which power the turn in both directions and with varying gradations of speed. PCA offers the user more convenience, independence and optimized precision to the task of collimating the primary mirror of a large dobsonian telescope.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention offers convenience, independence and precision to the task of collimating the primary mirror of large dobsonian telescopes in the field of astronomy. This will become apparent as we become familiar with the collimating process for dobsonian telescopes from the beginning. As a general introduction, the dobsonian telescope consists of the primary mirror located at the bottom of a cylindrical configuration and aligned by a solid tube, or several truss tubes in larger models, to the upper tube assembly which houses the secondary mirror placed at a 45 degree angle from the focuser. Perpendicular to the secondary mirror is the focuser where eyepieces of varying focal lengths (degrees of magnification) are inserted to view the celestial objects reflected off the primary mirror onto the secondary mirror. For clarity and understanding, please view FIGS. 1 and 2 where parts pertaining to collimation are labeled (primary, secondary, focuser).

Collimation is all about aligning the primary mirror, secondary mirror and focuser. While this invention solely pertains to the collimation of the primary mirror, this is the last step in the collimation process. As a general introduction to the subject, some actions need to occur first. The focuser (which houses the eyepieces that are placed in it) must be squared within the upper tube assembly. This is usually not a problem with well made telescopes. The secondary mirror then needs to be adjusted so that it is correctly aligned and squared with the focuser. This is usually accomplished by placing a laser collimation tool into the focuser which shines a beam onto the secondary mirror. The laser beam needs to hit the center of the secondary mirror, or a minor offset from the center as some would advocate. The secondary mirror is adjusted so that this occurs. Once this is accomplished, the secondary mirror is collimated so that the laser beam hitting its center is also reflected onto the exact center of the primary mirror. Adjustment screws on the secondary mirror are turned which tilts the angle of the mirror so that the beam from the secondary mirror hits the center of the primary mirror. By the way, the center of the primary mirror is often marked by a small round black ring made of tape. This enables one to easily locate the exact center of the primary. Once the focuser is squared and the secondary mirror is collimated, it is time to collimate the primary mirror.

The squaring of the focuser occurs once if at all. Once collimated, the secondary mirror is fairly stable and does not need to be adjusted again unless it get hit or moves. The collimation of the primary mirror of large dobsonian telescopes, however, needs to be checked and adjusted every time it is assembled on site (parts: base, mirror box housing the primary, truss tubes or solid tube housing the primary and secondary mirror, upper tube assembly, light shroud.

When a large dobsonian telescope is assembled on site, collimation of the primary mirror always occurs to optimize the image quality you see. This is the last step in the collimation process and the focus of this invention.

There are three main techniques for collimating the primary mirror of a dobsonian telescope. Firstly, a laser collimation tool is inserted in the focuser tube and turned on. The laser beam first hits the center of the secondary mirror which deflects it at a 45 degree angle onto the primary mirror which then reflects that light back upward toward the secondary mirror. This is the return beam. The return beam needs to be exactly aligned with the original beam hitting the center (or center offset) of the secondary mirror. This is done through observation of the two beams, the original beam and the return beam. The return beam is usually located somewhere on the secondary mirror if prior collimation was fairly accurate. Turning the collimation knobs at the back of the primary mirror will modify its tilt and move the return beam into alignment with the original beam on the secondary mirror. See FIG. 3 showing the location of the three collimation knobs at the back of the primary mirror of a dobsonian telescope.

The assessment of whether the primary mirror was successfully collimated is to look squarely at the secondary mirror at the level of the focuser. Usually one person is turning the collimation knobs in back of the primary which moves the return beam on the secondary while the other person is looking squarely at the secondary to assess collimation. Or worse, one person is turning the collimation knobs in the back of the primary then going to the secondary, at focuser level location, to assess the beam alignment. This process occurs over and over again, back and forth until collimation is achieved. The distance between the focuser and the primary can be over 11 feet in large dobsonian model telescopes. When the two laser point beams on the secondary become one, through adjustment of the collimation knobs on the back of the primary mirror, the task is complete. The optical axis of the primary mirror and the optical axis of the eyepiece (through the focuser onto the secondary) are brought into precise alignment.

The second method of collimation of the primary mirror of a dobsonian telescope is called the “barlowed laser” procedure. A barlowed laser collimation tool is inserted into the focuser and turned on. The light forming this beam is diffuse as opposed to being narrow and intense like a regular laser beam discussed earlier. This diffuse beam hits the secondary, is deflected to the primary and back onto the focuser from which it originated. However the return diffused beam of light that is reflected back contains the shadow of the center ring of the primary mirror. This doughnut shaped ring, which marks the exact center of the primary mirror, needs to be perfectly aligned with the center of the output draw tube of the focuser. Turning the collimation knobs at the back of the primary mirror will modify its tilt and move the ring to the center of the output hole. Note FIG. 4 showing the shadow of the center ring of the primary not quite in the center of the crosshairs of the focuser draw tube. FIG. 5 illustrates another model of Barlow laser which is placed into the focuser and reflects the diffuse return beam of light that is coming off the primary onto the secondary and back through the focuser. Turning the collimation knobs at the back of the primary will properly place the shadow of the black ring of the primary (its exact center) around the center dot in view.

The optical axis of the primary mirror and the optical axis of the eyepiece (through the focuser onto the secondary) need to be brought into precise alignment. The assessment of whether the primary mirror is successfully collimated using the barlowed laser technique is to look squarely at the output hole of the focuser or the barlowed laser combination tool display at the focuser location. Trips to the back of the primary to turn the collimation knobs which control its tilt and the direction of the return beam are necessary.

The third method of collimation of the primary mirror of a dobsonian telescope is to use the “cheshire” eyepiece collimation tool. This is a black tube with a tiny hole in the center with a built in cross hair like a rifle scope. It is inserted into the focuser. To collimate the primary, one turns the collimation knobs in the back of the primary mirror until the black ring placed on the center of the primary appears centered on the cross hairs of the Cheshire eyepiece when looking through it, like FIG. 6. In the end, the secondary mirror and center of the primary appear concentric when looking through the cheshire which is inserted in the focuser.

As noted in the previous discussion about primary mirror collimation in large dobsonian telescopes, either two individuals are required (one at the focuser location assessing the collimation task while the other is in back of the primary turning the collimation knobs) or one individual goes back and forth from focuser location to the back of the primary to collimate the primary. The latter scenario invites the possibility of settling with a less than precise collimation outcome so one can get on with the pleasure of observing the heavens! Wouldn't it be more convenient and advantageous to be able to precisely turn the collimation knobs by remote control while assessing the status of primary collimation at the proper location?—This is the focus of the current invention for which a patent is being requested. The new invention titled Primary Collimation Assist simplifies the primary collimation process in a very practical way for owners of large dobsonian telescopes.

### BRIEF SUMMARY OF THE INVENTION

The object of this invention is to bring more convenience, independence and possibly more precision to the task of collimating the primary mirror in large dobsonian telescopes. Primary Collimation Assist will turn collimation knobs by remote control using servo motors via a transmitter/receiver for collimation of the primary mirror. Collimation is very precise. While collimating the primary:
you are looking squarely at the secondary mirror for laser collimation
you are looking squarely at the output hole of the return beam (primary center doughnut ring) using the barlowed laser technique
you are looking directly through you sight tube/cheshire collimation tool

This eliminates the need to have another person turn the collimation knobs while one assesses the collimation accuracy at the location of the focuser (independence). It also eliminates the need for one person to shift back and forth from the back of the primary mirror to the eye level location of the focuser during the collimation process (convenience). It optimizes collimation precision because the collimation knob turns in small gradations of speed depending on the pressure exerted on the transmitter joystick.

### BRIEF DESCRIPTION OF THE SEVERAL VIEWS OF THE DRAWINGS (PHOTOS)

No doubt this invention will definitely be shown more clearly in photographs.

FIGS. 1 and 2 are examples of large dobsonian telescopes

FIG. 3 shows where collimation knobs appear on dobsonian telescopes

FIGS. 4 and 5 are examples of a barlowed laser

FIG. 6 shows a well collimated scope looking through the cross hairs of the Cheshire eyepiece

FIG. 7 is the transmitter.

FIG. 8 is the receiver.

FIG. 9 is the servo motor.

FIG. 10A are two machined aluminum socket fittings 1⅜ inch in diameter.

FIG. 10B shows the bottom view of the same aluminium socket fittings (FIG. 10A) with its corresponding servo horns having a star and round shape. This just illustrates the fact that several servo horns are available for a given servo motor. Either the star or round shaped servo horn is used in the current invention. Each aluminium socket fitting is machined on the bottom to mate with its corresponding servo horn.

FIG. 10C shows how the same servo horns are affixed to the bottom aluminium socket fittings of FIGS. 10A and 10B which are machined to allow the horns to fit into them. They are adhered by epoxy glue.

FIG. 11 shows an aluminum socket fitting containing a center magnet of 0.5 inches diameter permanently attached to the servo horn of the motor.

FIG. 12A shows the aluminum socket fitting permanently attached to the servo horn with the wires attached to both sides of the servo motor culminating in a Velcro “pad.”

FIG. 12B shows a side view of FIG. 12A.

FIG. 13 shows the battery pack consisting of four AA batteries (6 volts total) which is wired to an on/off switch which in turn is wired to the receiver.

FIG. 14 shows the complete wiring of the servo motors to the receiver in addition to the battery pack and on/off switch.

FIG. 15A shows how the left motor wire is bent prior to engaging the aluminium fitting to the collimation knob.

FIG. 15B shows how both wires of the same motor (FIG. 15A) are bent prior to engaging the aluminium fitting to the collimation knob.

FIG. 16 shows the usage requirement of having a structural support beam adjoining the collimation knob within the telescope's mirror box so as to adhere the two Velcro pads of the motor assembly (as observed in FIGS. 12A and 12B) to the pre-placed Velcro strips on the upper side of the support beam (see arrows pointing to the pre-placed Velcro strips in FIG. 16.

FIG. 17 shows the motor with attached aluminium fitting engaged with the collimation knob.

FIG. 18 shows the complete assembly of Primary Collimation Assist. FIG. 18 is a color photo which also serves as the “front page view.”

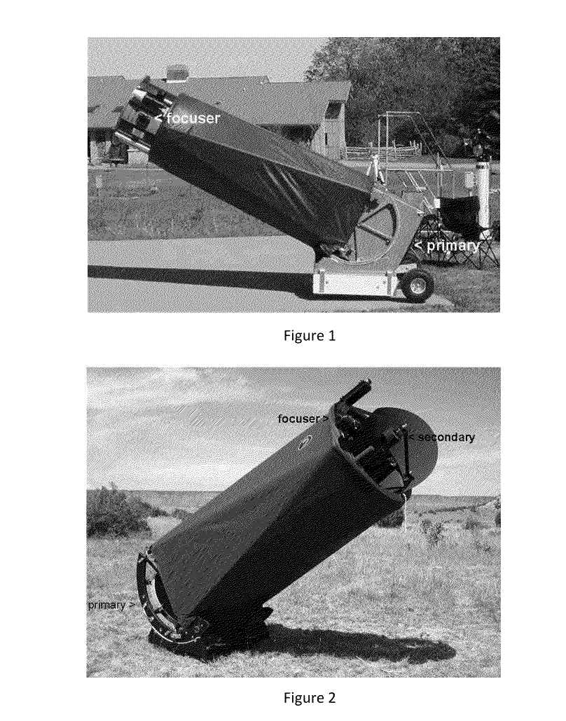

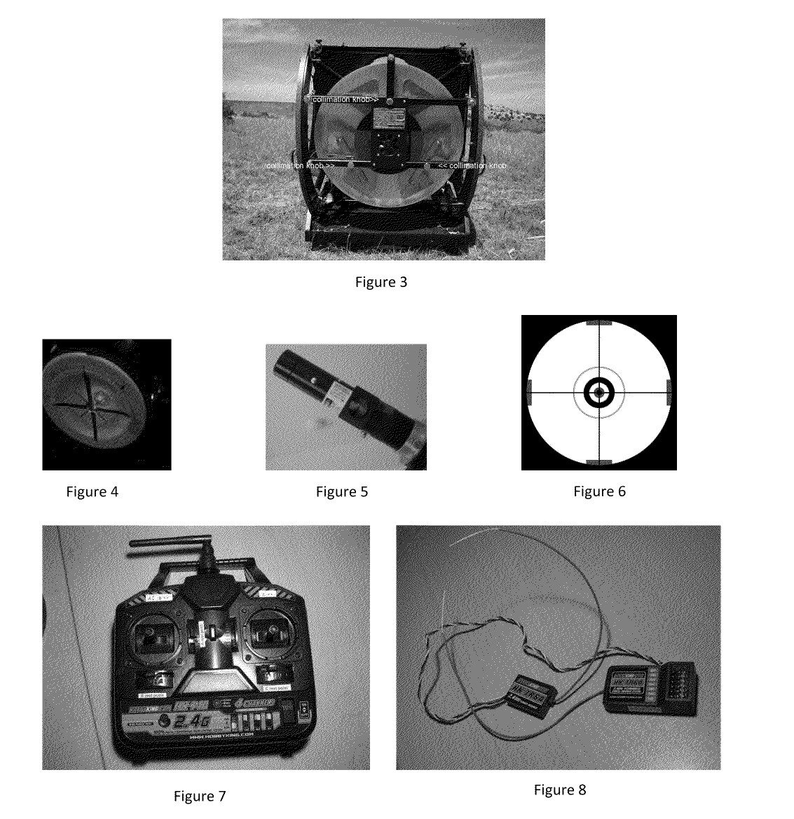

### DETAILED DESCRIPTION OF THE INVENTION

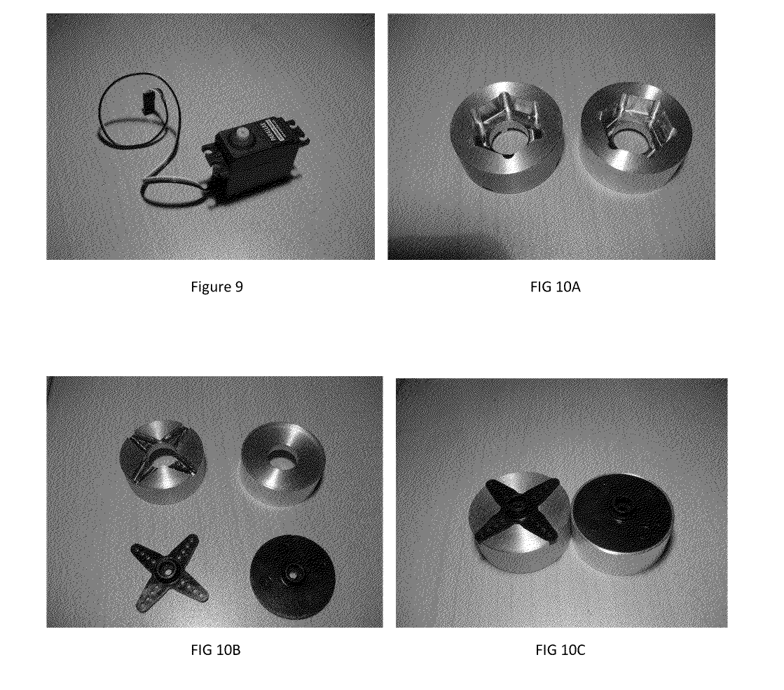

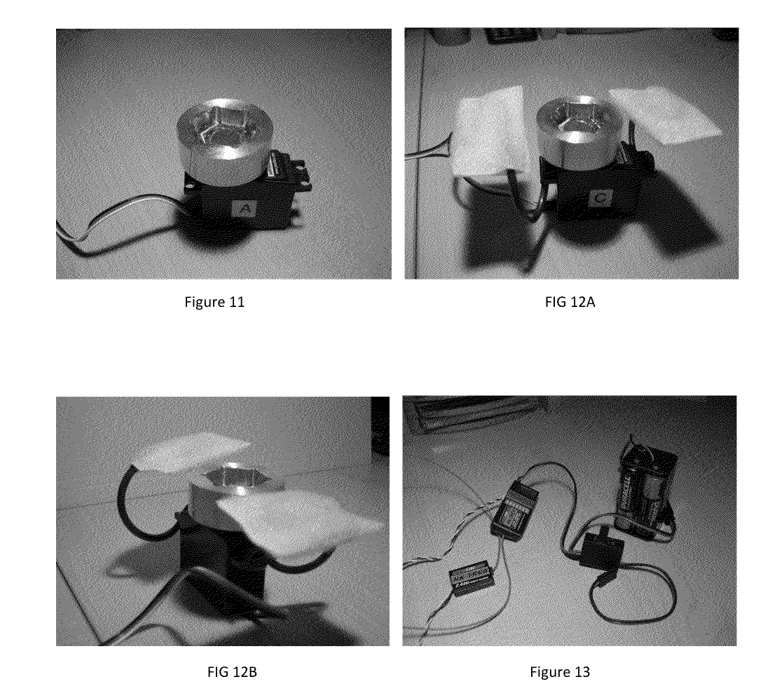

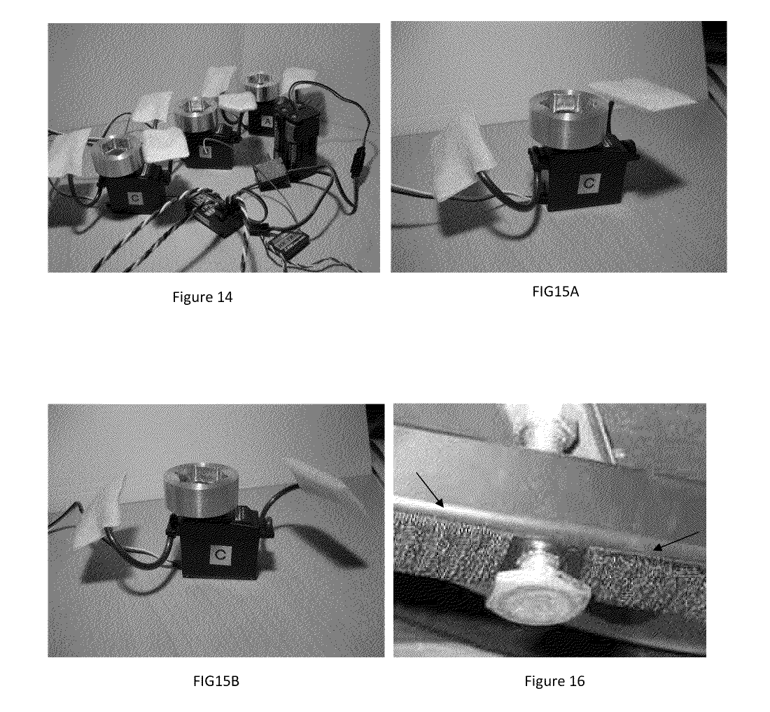

This invention consists of a transmitter such as 2.4 Ghz 4 channel radio control system (FIG. 7) used here with a 6 channel receiver (FIG. 8). Any receiver with 6 channels or more will do. Such is found in hobby shops. The Transmitter first needs to be “binded” to the receiver for the system to operate. This is accomplished by connecting the bind plug to the ‘BAT” channel of the receiver and connecting the battery source to channel 3 of the receiver. Hold “bind range test” button on and turn on the Transmitter. When the red light on the receiver stops blinking turn the transmitter off and remove the bind plug from the receiver. The transmitter is now binded to the receiver. Servo motors (FIG. 9) which offer continuous rotation in both directions and have sufficient torque (greater than 35 ounces per inch) are wired to the receiver. An extension lead wire is used from the motor to the receiver to allow more wire room to place the motor fitting to the collimation knob. Each joystick control on the transmitter is labelled to correspond to the motor that it operates. Each motor is labelled A, B, or C on its front. The joysticks on the transmitter, which control the forward and reverse direction and variable speed of each motor are marked on the transmitter along with each motor's resting point controls, that is, the control to regulate and stop the turning of the motor and put it “at rest,” if necessary (FIG. 7). The receiver is also wired to a battery pack (FIGS. 13 and 14) consisting of 4 AA batteries, 6 volts total, which is controlled by an on/off switch. The Potentiometer on each motor is pre-calibrated once by turning of the potentiometer adjustment screw on the motor while the motor battery switch is in the “on” position while the transmitter is turned off to achieve its motion center-point (rest point). This does not need further adjustment. Any additional refinement of the motion resting point of each motor is achieved by regulating the rest point controls on the transmitter.

A machined aluminium fitting with a ⅞ inch socket (FIG. 10 A,B,C) is adhered (by epoxy glue) to the servo motor horn containing center spines which fit in to the servo motor rotor itself (zoom in to FIG. 9). Round servo horns (1⅜″) and star servo horns (1½″) work best with this application. Either a round or star horn may be used. The aluminium fitting must be machined to fit the horn being used. Epoxy glue is used to permanently adhere the aluminium socket fitting to the servo horn. The aluminium socket fitting must correspond to the shape and size of the collimation knob. There are various collimation knobs in existence used by many telescope companies, including folks who build their own dobsonian telescopes. The first version of Primary Collimation Assist uses a common but not universal socket fitting that is hexagonal in shape with a ⅞ inch socket size.

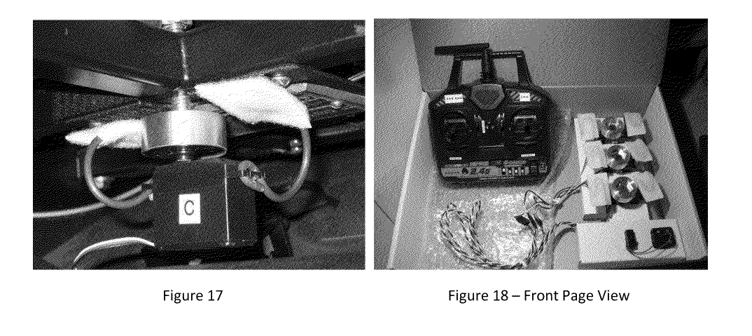

Wire of 14/2 gauge, are attached to each side of the motor and culminate in Velcro “pads” (FIGS. 12A and 12B). The wire is bent to be shaped like a loop at the end and white Velcro is then wrapped around the wire shaped loop. The adhesive of the Velcro adheres to the wire loop. Such velcroed wire with a characteristic round shape is attached to each side of the motor” (FIGS. 12A and 12B), which provides spring like stability when the aluminium fitting is engaged in the knob. The white Velcro adhered to the wire is intended to be mated to its black Velcro counterpart located on the top of the upper support beams or ceiling of the primary mirror box (FIG. 16) to hold the motor in place once the collimation knob is placed into the aluminium socket fitting by the user of this invention. Therefore, two usage requirements of this invention (version1) are that the collimation knob be hexagonal in shape with a ⅞ inch socket size. The second requirement is that the dobsonian telescope has upper adjoining structural support beams in the mirror box or ceilings housing the collimation knob to attach two inch black Velcro strips so as to hold the motor in place (FIG. 17).

This invention initially requires installation of 2 two inch black Velcro strips to the underside of the support beams or ceilings adjoining the three collimation knobs. FIG. 16 illustrates an example of how the Velcro strips are adhered for one of the collimation knobs. Included in the PCA kit are six black Velcro strips each 2 inches long. For each of 3 collimation knobs, the user must first firmly adhere the Velcro strips to the underside of the support beam on both sides of the collimation knob as mentioned earlier.

To begin operation of Primary Collimation Assist, the motor battery switch is turned on and the transmitter is turned on. The “rest point” controls on the transmitter have already been pre-set. The motors should not be turning. However if slight turning occurs, each motor may easily be adjusted by slightly adjusting the “rest point” controls as labeled on the transmitter for whichever motor is turning (zoom in on FIG. 7). One may wish to adjust motor rest points on the transmitter as the need arises.

The next step is to place or engage the aluminum motor fittings to the collimation knobs. Before placing the collimation knob inside the aluminum fitting, the motor wires need to be bent so you have some clearance when you engage the fitting to the knob, otherwise the Velcro would get in the way. Place thumb on the side of the white Velcro and bend each wire in a circular downward direction toward the side away from the motor. FIG. 15A shows how the left motor wire is bent prior to engaging the aluminium fitting to the collimation knob. FIG. 15B shows how both wires of the same motor are bent prior to engaging the aluminium fitting to the collimation knob. Then, while firmly holding the motor, turn it until the knob is inside the aluminum fitting. The center magnet within the aluminum fitting enhances this engagement. Grip and hold the aluminum fitting with one hand while gently turning the motor so it is parallel with the support beam above. While holding the motor and keeping slight upward pressure on the knob, tuck the white Velcro on one side of the motor to the black Velcro vertically positioned on the underside of the support beam above. Press firmly upwards on the white Velcro. Do the same for the other side placing the white Velcro against the black Velcro on the underside of the support beam above. Position the motor fitting so that it is fairly flush with the knob and aligned vertically (FIG. 17). There may be times when the motor wires need to be adjusted in height to maximize the aforementioned procedure.

The next step is to place oneself in a convenient location in the area of the focuser so as to assess the collimation task, regardless of which method of primary collimation is chosen. The primary mirror is collimated by using the transmitter controls to turn the collimation knobs by remote control. Slight pressure on the joystick will turn the collimation knobs slowly; more pressure will turn the knobs faster. Continue adjusting until collimation is very precise.

When the task is completed, turn off the transmitter immediately to avoid accidental pressure on the joysticks after precise collimation of the primary is complete. Turn the motor battery switch off or else the batteries which are wired to the receiver will get drained. Remove the aluminum motor fittings from the collimation knobs by gently pulling down on the motor just enough to disengage the aluminum fitting from the knob—no more. Place both index fingers behind and in the back of each of the white Velcro pads where it attaches to the black Velcro strips at the upper beam. Support the motor with you thumb and forefingers. Peel the white Velcro pads off from back to front with an upward circular motion using your index fingers as levers. Peel the Velcro off so as not to stretch the round shaped wires too much. The wires should keep their rough shape as mentioned earlier.

To summarize the complete usage operation: turn the motor battery switch on and the transmitter on. Adjust the motor motion “rest points” on the transmitter if necessary; place the aluminum motor fittings so each collimation knob is inside its socket and attach Velcro as previously outlined; place yourself in a convenient location to assess your collimation task; collimate your primary mirror using the transmitter controls to turn the collimation knobs by remote control; after precise collimation has been achieved, immediately turn the transmitter off, turn the motor battery switch off, and remove the motor fittings from the collimation knobs as previously outlined.

The embodiments of the invention in which an exclusive property or privilege is claimed are defined as follows:

1. A means of collimating the primary mirror of a dobsonian telescope consisting of a transmitter binded to a receiver; servo motors or electrically driven motors wired to said receiver, which is permanently affixed with machined socket fittings corresponding to the shape and size of the collimation knobs used by said telescope, to turn each collimation knob at variable speed increments by remote control for the purpose of adjusting the tilt of the primary mirror so as to align its reflected optical axis in the focuser; thereby “collimating” it by the user completely at the location of the focuser during its entire operation.

2. As the socket fittings mentioned in claim 1 are made of aluminium, they lighten the load to be placed on the Velcroed wires supporting the weight of the motor when engaged with the collimation knob.

3. The aluminium socket fittings in claim 2 contain a permanently installed magnet of 0.5 inches in diameter which promotes engagement of the fitting to the metal collimation knob because of its magnetic attraction.
